(19) United States
(12) Patent Application Publication
(10) Pub. No.: US 2015/0205350 A1
(43) Pub. Date: Jul. 23, 2015

(54) SKIN MOUNTED INPUT DEVICE

(71) Applicant: Lenovo (Singapore) Pte. Ltd., New Tech Park (SG)

(72) Inventors: Russell Speight VanBlon, Raleigh, NC (US); Axel Ramirez Flores, Cary, NC (US); Jennifer Greenwood Zawacki, Hillsborough, NC (US); Alan Ladd Painter, Cary, NC (US)

(73) Assignee: Lenovo (Singapore) Pte. Ltd., New Tech Park (SG)

(21) Appl. No.: 14/162,115

(22) Filed: Jan. 23, 2014

(51) Int. Cl. G06F 3/01

(52) U.S. Cl. CPC G06F 3/014

(57) ABSTRACT

A skin mounted input device includes a sensor for sensing contact with a surface and a wireless transceiver for sending an input command responsive to signals from the sensor.

### I. FIELD

The present application relates generally to skin mounted computer input devices.

### II. BACKGROUND

Computing devices such as e.g. notebook computers and smart phones typically receive input from mice, keyboards, keypads, and the like. Present principles recognize that conventional input modes may not be adequate for certain applications.

### SUMMARY

Accordingly, in a first aspect an apparatus includes a mount which engages with a person's body, and at least one sensor on the mount. At least one wireless transceiver is on the mount which receives signals representative of the sensor sensing a relationship between the apparatus and at least one object that is not part of the apparatus. The wireless transceiver sends at least one input command to a computer responsive to the signals.

In another aspect, a device includes at least one skin mount which removably mounts to a person's body. At least one sensor is coupled to the skin mount which senses contact with a surface, and at least one wireless transceiver is included which sends an input command to a computer responsive to at least one signal from the sensor.

In another aspect, a method includes receiving at least one signal from an apparatus adhered at least partially to a person's hand, and transmitting a command to a computer responsive to the signal.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an exemplary device in accordance with present principles;

FIG. 2 is a block diagram of a network of devices in accordance with present principles;

FIG. 3 shows an example system that can use one or more of the components in FIGS. 1 and 2, illustrating a first embodiment of a finger-borne input device;

FIG. 4 shows an example system that can use one or more of the components in FIGS. 1 and 2, illustrating a second embodiment of a finger-borne input device that may be used alone or in combination with the input device of FIG. 3; and

FIGS. 5 and 6 are flow charts of example logic.

### DETAILED DESCRIPTION

This disclosure relates generally to (e.g. consumer electronics (CE)) device based user information. With respect to any computer systems discussed herein, a system may include server and client components, connected over a network such that data may be exchanged between the client and server components. The client components may include one or more computing devices including televisions (e.g. smart TVs, Internet-enabled TVs), computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

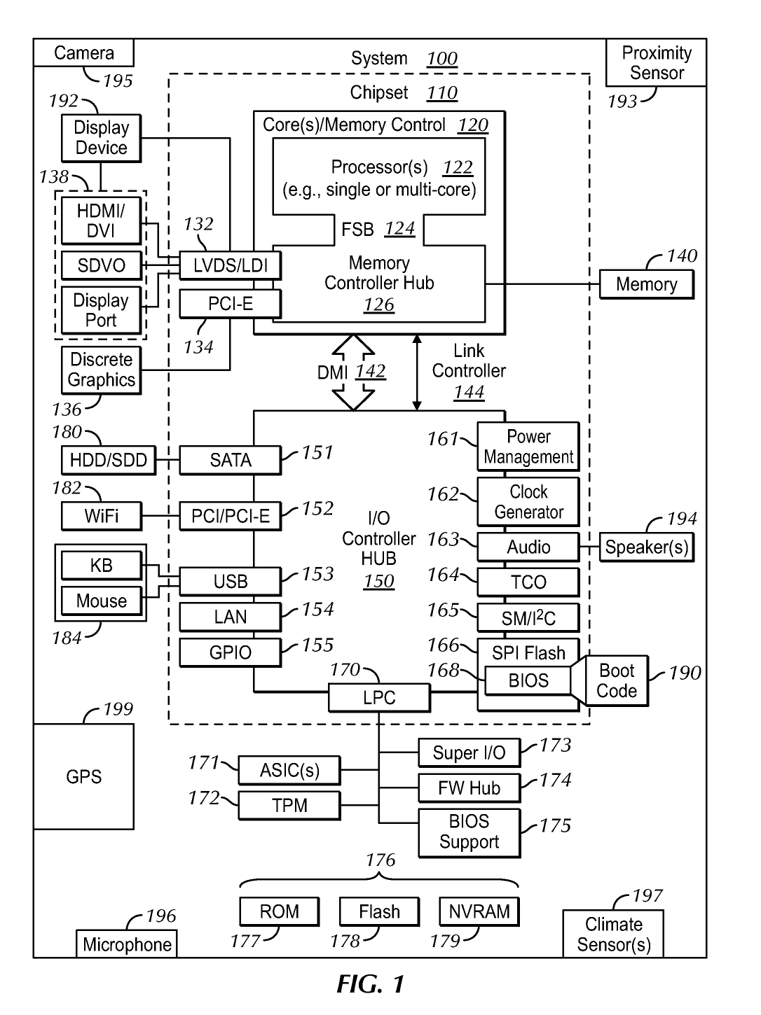

Now in reference to FIG. 1, it shows an exemplary block diagram of an exemplary computer system 100 such as e.g. an Internet enabled, computerized telephone (e.g. a smart phone), a tablet computer, a notebook or desktop computer, an Internet enabled computerized wearable device such as a smart watch, a computerized television (TV) such as a smart TV, so-called “convertible” devices such as e.g. a tablet that may be converted to a laptop by virtue of being connected to a soft keyboard, and/or other smart devices, etc. Thus, in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An exemplary system may include AGP or PCI-E for support of graphics.

The I/O hub controller 150 includes a variety of interfaces. The example of FIG. 1 includes a SAT A interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 also may include sensors and/or a sensor array including e.g. a proximity, infrared, sonar, and/or heat sensor 193 providing input to the processor 122 and configured in accordance with present principles for sensing e.g. body heat of a person and/or the proximity of at least a portion of the person to at least a portion of the system 100 such as the sensor 193 itself. Also in some embodiments, the system 100 may include one or more cameras 195 providing input to the processor 122. The camera 195 may be, e.g., a thermal imaging camera, a digital camera such as a webcam, and/or a camera integrated into the system 100 and controllable by the processor 122 to gather pictures/images and/or video in accordance with present principles (e.g. to gather one or more images of eyes to apply eye tracking software to the image(s) as set forth below). Moreover, the system 100 may include an audio receiver/microphone (e.g. a microphone or microphone array) 196 for e.g. entering input such as a command to the system 100 in accordance with present principles.

In addition to the foregoing, the system 100 may include one or more climate sensors 197 (such as e.g., an (e.g. ambient) light sensor, a temperature sensor, a humidity sensor, and/or an environmental sensor) providing input to the processor 122. The system 100 may also include one or more motion sensors 198 (such as e.g., an accelerometer and/or a gesture sensor (e.g. for sensing gestures in free space associated by the device with commands in accordance with present principles), etc.) providing input to the processor 122 in accordance with present principles. Though not shown, still other sensors may be included and their output used in accordance with present principles, such as e.g. biometric sensors, sound sensors, orientation sensors, location sensors, scan sensors, and/or time sensors. Also note that a GPS transceiver 199 is shown that is configured to e.g. receive geographic position information from at least one satellite and provide the information to the processor 122. However, it is to be understood that another suitable position receiver other than a GPS receiver may be used in accordance with present principles to e.g. determine the location of the system 100.

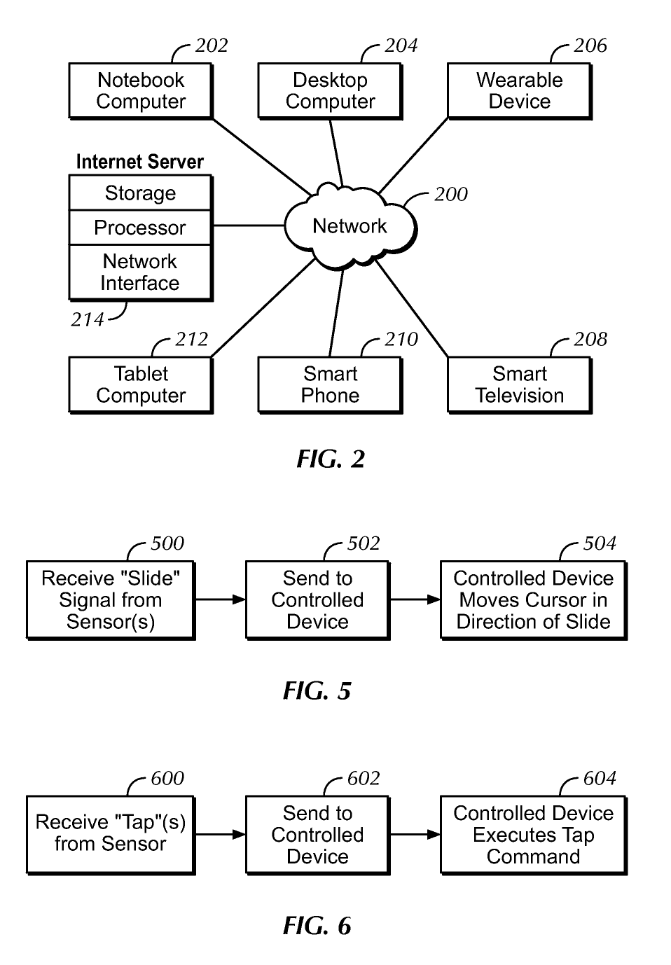

Before moving on to FIG. 2 and as described herein, it is to be understood that an exemplary device or other machine/computer may include fewer or more features than shown on the system 100 of FIG. 1. In any case, it is to be understood at least based on the foregoing that the system 100 is configured to undertake present principles.

Turning now to FIG. 2, it shows exemplary devices communicating over a network 200 such as e.g. the Internet in accordance with present principles is shown. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 2120, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

As used herein, “mount configured for removable engagement with a person's body” and “skin mount configured for removably mounting to a person's body” may not encompass conventional computer mice, trackballs, and joysticks, but rather refers to a mount that adheres to or grips or otherwise couples to the body, e.g., a finger, so that a user may lift the part of the body to which the mount is coupled in the air with the mount on the bottom of the part of the body to which the mount is coupled without falling off, without support from below from another object.

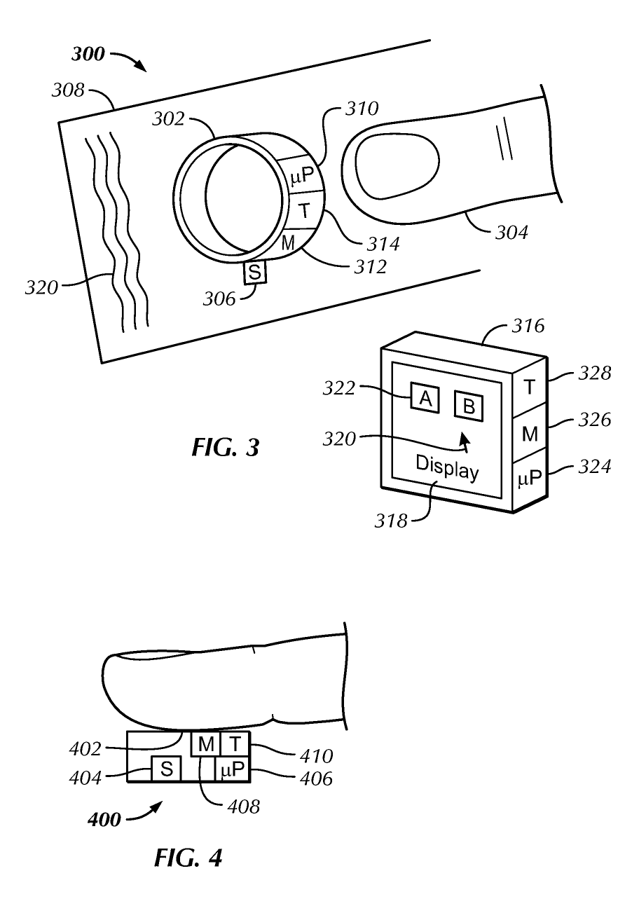

FIG. 3 shows a finger-mounted input device 300 in which a ring-shaped (completely or partially) mount 302 that is configured for close engagement with a human's body and in the specific embodiment shown with a finger 304 bears one or more sensors 306 for sensing contact with or proximity to a surface 308 or otherwise sensing motion in space. The sensor 302 may include a camera and/or an optical sensor similar to those used on optical mice, and/or a magnet, and/or a contact sensor such as but not limited to piezo-based contact sensor, a force sensing resistor (FSR), etc. Or, the sensor 302 may include an accelerometer or gyroscope to indicate motion of the mount 302 in free space for generating the below-described slide signal. Signals from the sensor(s) 306 representative of contact with and/or proximity to the surface 308 can be sent to a processor 310 on the mount 302 which may access instructions on a solid-state or disk-based computer memory 312 to send input commands based on the sensor(s) signal through a transmitter 314 to a controlled computer device 316 that typically includes a display 318 presenting a movable cursor 320 and one or more selector elements 322. The controlled device may be, for example, any one of the devices shown and described previously. Typically the controlled device 316 includes a processor 324 accessing a computer memory 326 to process signals from the sensors 302 that are received through a receiver 328. The transmitter 314 and receiver 328 may communicate via wired (e.g., universal serial bus or Ethernet or other) paths or via wireless paths such as but not limited WiFi, Bluetooth, infrared (IR), sonic paths, etc.

FIG. 4 shows an alternate finger mounted input device 400 which has a biocompatible adhesive on a finger surface 402 that adheres to a finger as shown. The device 400 includes one or more sensors 404 communicating contact and/or proximity signals to a processor 406 accessing a computer memory 408 to send commands to, for example, the controlled device 316 through a transmitter 410. Multiple finger-mounted input devices 300 and/or multiple input devices 400 may be used in a single system to input commands to the controlled device 316 according to logic herein.

Now in reference to FIG. 5, an example flowchart is shown of example logic to be executed by a device such as the system 100 and/or finger-mounted input devices 300/400 in combination with the controlled device 316 described above (e.g. such a device undertaking the logic of FIG. 5 referred to when describing FIG. 5 as “the device”) in accordance with present principles. Beginning at block 500, a “slide” signal is received by the finger-mounted processor 310 from the sensor(s) 306. For example, when the sensor 306 is a camera or optical sensor it may output a signal the visible or IR images of which indicate motion of the mount 302 over the surface 308. The slide signal may indicate a direction and speed. When the sensor 306 is an accelerometer it outputs a signal representative of motion of the mount 302 in free space to establish the slide signal. A contact sensor may generate multiple contact signals in sequence along a direction against which the sensor 306 is moved. The same principles apply to the sensor 404 shown in FIG. 4.

At block 502 the finger-mounted processor 310 causes a command such as a “move cursor” command or “raise (or lower) audio volume” command or other command based on the slide signal to be sent to the controlled device 316, which executes the command at block 504 by, e.g., moving the cursor 320 on the display 318 in a direction and, if desired, at a speed defined by the slide signal generated by the sensor 306.

Block 600 of FIG. 6 shows that “tap” signals may be generated by the sensor(s) 306, 404 and corresponding input command(s) sent to the controlled device 316 at block 602 to be executed by the controlled device at block 604. A “tap” signal may be generated by a contact sensor or by a magnetic sensor indicating a magnetic signal strength above a threshold or by an optical sensor indicating an IR return signal above a threshold or by other suitable means. Note here that the correlations between “slides” and corresponding commands and “taps” and corresponding commands may be preprogrammed into the finger-mounted processors and/or controlled device processor executing a device driver associated with the finger-mounted input devices as is currently done for conventional mice.

As non-limiting examples of the above “tap” logic, a user's thumb or index finger on which a skin-mounted input device is mounted or engaged can slide on or near a surface to move a screen cursor. Tapping a singer to a surface, or tapping two fingers, each engaged with a skin-mounted input device, can input a “left” or “right” mouse click command to the presentation device. Finger taps may also be used to send a signal to a phone (as presentation device) indicating not answering a call or answering a call using speaker phone features. Finger taps may be used to cause an audio video player to skip a film chapter in a presented audio video program or to cause an audio player to skip an audio track, etc.

Rubbing or sliding two fingers (with respective skin-mounted input devices) against each other or against an inanimate surface may be used for scrolling, changing audio volume, etc. Two dimensional scrolling may be effected using two fingers (with respective skin-mounted input devices) with one acting as a surface, or one finger (with respective skin-mounted input device) on another surface.

With multiple skin-mounted input devices on respective fingers, different fingers may be used for different commands. For example, thumb plus middle finger tapping may be used to answer a telephone call, while thumb plus index finger tapping can be used to decline a call. Or, rubbing the thumb input device against the index finger input device can generate a normal speed scrolling command, while rubbing the thumb input device against the middle finger input device can generate a fast speed scrolling command. Click/select commands may be generated upon separation of two finger-mounted input devices instead of on contact of the devices.

A certain texture or type 320 (FIG. 3) of surface may be detected and used exclusively as a “mouse pad” so that a finger-mounted input device performs any or all of its functions only if moved or tapped against that certain type of surface. The surface may be characterized for this purpose by a material type, by being magnetic, by being a particular color, by having a particular texture (e.g., coarse, bumpy, etc.)

A single sensor and mount may be used to detect movements between a skin device and a surface. The other surface may be another skin-mounted input device, a desk top, etc. The skin-mounted input device can communicate with the input (for example, I/O) controller of a presentation device to send the presentation device input commands such as cursor movement commands and graphics element select commands. The communication link between the presentation device and skin-mounted input device may be wired or wireless, e.g., Bluetooth or WiFi or ultra wideband (UWB) or the like.

Without reference to any particular figure, it is to be understood that present principles apply mutatis mutandis to e.g. devices that when engaged with a user may be permanently or semi-permanently engaged with a user's body, such as e.g. an implantable skin device.

Also without reference to any particular figure, note that input as detected by a sensor in accordance with present principles and/or data from a user in accordance with present principles may be cached e.g. at the input device itself in some instances. E.g., input may be collected on a skin-mounted input device and cached thereat if e.g. another computing system such as the system 100 cannot be communicated with to provide the input thereto at the time the input is collected by the sensor. One example embodiment of this may be when e.g. taking notes on a table top using a finger with a skin-mounted device located thereon, but while a smart phone configured to communicate with the skin-mounted device is not nearby or is otherwise unavailable. Thus, the skin-mounted device may collect the input (e.g. based on the writing on a table top) and when the smart phone does become available, the skin-mounted device may transfer the “notes” collected by the skin-mounted device from the skin-mounted device's cache to the smart phone.

While the particular SKIN MOUNTED INPUT DEVICE is herein shown and described in detail, it is to be understood that the subject matter which is encompassed by the present application is limited only by the claims.

1. An apparatus, comprising:
a mount which engages with a person's body;
at least one contact sensor on the mount, wherein the contact sensor senses contact of at least a portion of the apparatus at least with an inanimate object that, is not, part of the apparatus; and
at least one wireless transceiver on the mount which receives signals representative of the contact sensor sensing contact between the apparatus and the inanimate object.

2-7. (canceled)

8. The apparatus of claim 1, wherein the signals indicate a sliding motion of at least a portion of the apparatus against the inanimate object.

9. (canceled)

10. A device comprising:
at least one mount which removably mounts to a person's body;
a processor;
at least one sensor coupled to the mount and accessible to the processor; and
at least one tireless transceiver accessible to the processor and which transmits date to a computer, wherein the processor controls the at least one wireless transceiver to transmit the data at least in response to the computer becoming available for data transmission from a state in which the computer was unavailable for data transmission, the data associated with at least one signal from the sensor.

11-16. (canceled)

17. Method comprising:
receiving at least one signal from a first apparatus engaged at least partially with a first portion of person's hand and receiving at least one signal from a second mount engaged at least partially with a second portion of the person's hand different from the first portion; and
based on movement of the first mount relative to the second mount identified at least in part based on at least one signal from the first mount and at least one signal from the second mount, transmitting a command to a computer.

18-19. (canceled)

20. The apparatus of claim L wherein the contact sensor generates contact signals in sequence as at least a portion of the apparatus is moved against the inanimate object.

21. The apparatus of claim U wherein the contact sensor is a piezo-based contact sensor.

22. The apparatus of claim 1, wherein the contact sensor is a force sensing resistor (FSR).

23. The apparatus of claim 1, comprising:
an element actuatabie to Identify at least one characteristic of an object.

24. The apparatus of claim 23, comprising:
a processor, wherein the contact sensor and the element are accessible to the processor;
wherein the processor actuates the element to at least attempt to identify at least one characteristic of the inanimate object.

25. The apparatus of claim 24, wherein responsive to identification of the at least one characteristic of the inanimate object, the processor performs at least one function based on contact of at least a portion of the apparatus with the inanimate object.

26. The apparatus of claim 25, wherein the at least one characteristic of the inanimate object comprises a first characteristic, wherein the inanimate object is a first inanimate object, and wherein responsive to identification of a second characteristic of a second inanimate object the processor does not perform the at least one function based on contact of at least a portion of the apparatus with the second inanimate object.

27. The apparatus of claim 25, wherein responsive to a failure to identify the at least one characteristic of the inanimate object, the processor does not perform the at least, one function based on contact of at least a portion of the apparatus with the inanimate object.

28. The apparatus of claim 23, wherein rise element is the contact sensor.

29. The apparatus of claim 23, wherein the element is different from the contact sensor.

30. The apparatus of claim 23, wherein the at least one characteristic is at least one of a texture, a color, an object type, a material type, and a magnetic property.

31. The device of claim 10, comprising storage accessible to the processor, wherein the processor stores the data in the storage while the computer is unavailable for data transmission.

32. The device of claim 10, wherein the at least one sensor senses contact of at least a portion of the device at least with an inanimate surface.

33. The device of claim 32, wherein the data is associated with contact of at least a portion of the device with the inanimate object.

34. The method of claim 17, wherein the command is a first command, wherein the movement is a first movement, and wherein the method comprises:
based on second movement of the first mount relative to the second mount that is different from the first movement and that is identified at least in part based on at least one signal from the first mount and at least one signal from the second mount, transmitting a second command different from the first command to the computer.

35. The method of claim 17, comprising:
based on movement of the first mount relative to movement of the second mount identified at least in part based on at, least one signal from the first mount and at least one signal from the second mount, transmitting the command to a computer.
